(19) United States
(12) Patent Application Publication
(10) Pub. No.: US 2007/0065638 A1
(43) Pub. Date: Mar. 22, 2007

(54) Nano-structured thin film with reduced light reflection

(75) Inventors: Jin-Shan Wang, Pittsford, NY (US); Charles W. Lander, Wayland, NY (US); Craig C. Lewis, Rochester, NY (US); Gary A. Rakes, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/230,790

(22) Filed: Sep. 20, 2005

(51) Int. Cl. G11B 5/64

(52) U.S. Cl. 428/141

(57) ABSTRACT

The present invention is directed to a multilayer optical film, for use in a display or component thereof, comprising a substrate having a topmost layer that is an anti-reflective layer having a nano-structured surface, the layer comprising elongated-shaped silica particles. Another aspect of the present invention relates to a method of forming the single anti-reflective layer and its use in various applications including displays and components thereof.

### FIELD OF THE INVENTION

This invention relates generally to the field of optical films. More specifically, the invention relates to a single coating with anti-reflective properties and a process for manufacturing such a coating. The coatings typically exhibit a nano-structured surface.

### BACKGROUND OF THE INVENTION

In the field of optical films, substrates that are optically transparent are often smooth and, as is the case for all smooth coatings, this results in a certain degree of reflection of light from the coating/air interface. This property has been recognized in the art as a problem in many different applications. An example is the undesirable reflection of the glass at the front of a display device. Generally, this problem has been addressed by the use of applied coatings which are tailored in terms of thickness and refractive index in order to lead to improved anti-reflective performance, as measured by an increase in transmission of light with respect to the substrate.

It is known that an applied coating can achieve an increase in light transmission over the whole visible region of the light spectrum as part of a multilayer system of coatings in which each coating has a carefully selected thickness and refractive index, as in U.S. Pat. No. 5,582,859. The basic principle of such coatings can be understood in terms of destructive interference between light reflected from air-film and film-substrate interfaces. Glass or plastic substrates, for example, require that an anti-reflective film have a low effective refractive index n_{eff}≅1.2. Because of the lack of such low-refractive-index materials, this requirement cannot be realized with homogenous single-layer coatings and, therefore, multilayer coatings have been used.

Although a monolayer film can effectively reduce the reflection of light within a very narrow wavelength range, more often a multilayer film comprising several (typically, metal oxide based) transparent layers superimposed on one another is used to reduce reflection over a wide wavelength region (i.e., broadband reflection control). For such a structure, half wavelength layers are alternated with quarter wavelength layers to improve performance. A multilayer anti-reflection film may comprise two, three, four, or even more layers. Formation of such a multilayer film typically requires a complicated process comprising a number of vapor deposition procedures or sol-gel coatings, which correspond to the number of layers, each layer having a predetermined refractive index and thickness. Precise control of the thickness of each layer is required for these interference layers. The design of suitable multilayer anti-reflection films is well known in the patent art and technical literature, as well as being described in various textbooks and patents, for example, in H. A. Macleod, “Thin Film Optical Filters,” Adam Hilger, Ltd., Bristol 1985 and James D. Rancourt, “Optical Thin Films User's Handbook”, Macmillan Publishing Company, 1987 and U.S. Pat. No. 6210,858, the latter describing an anti-reflection multilayer film comprised of low refractive index layers containing inorganic fine particles. The refractive index reduction of the film is largely obtained by interstitial air voids. Multilayer films coatings suffer from three sets of problems. The first is that the anti-reflective performance of multilayer coatings suffers from angle-dependency. This means that transmission will vary from the normal to oblique angles. Secondly, reproducible processing of such multilayer coatings with precisely controlled thickness and optical properties is difficult and therefore costly and time-consuming. Third, it is a very expensive process.

Anti-reflection layers comprising a monolayer are also known. Typically, such monolayers provide reflectance values less than 1% at only a single wavelength (within the broader range of 450 to 650 nm). A commonly employed anti-reflection monolayer coating comprises a layer of a metal fluoride such as magnesium fluoride (MgF₂). This layer may be applied by well-known vacuum deposition technique or by a sol-gel technique. Typically, such a layer has an optical thickness (i.e., the product of refractive index of the layer times layer thickness) of approximately one quarter-wavelength at the wavelength where a reflectance minimum is desired. Commonly assigned copending application USSN 11/101,004, Filed Apr. 07, 2005 discloses a transparent support with an anti-reflection layer that is substantially conformed in shape to the surface underlying the layer. The anti-reflection layer contains polymer particles, dispersed in a binder polymer, that are spherical in shape and which are nanovoided so as to have a surface area greater than 50 m²/g.

Alternatively, a single coating can be made anti-reflective by forming a porous film having a controlled surface structure. Provided the pore size is less than a quarter wavelength, the porous film will appear as a continuous film with an effective refractive index given by an average over the film. The higher the volume fraction of the pores, the lower the n_{eff}. Based on this idea, various approaches have been developed. See, for example, Steiner et al., Science, Vol. 283, pp. 520-522 (1999); Ibn-Elhaj et al., Nature, Vol. 410, pp. 796-799 (2001); and WO 01/29148 A1. The latter discloses the formation of a topologically structured polymer film by homogenously mixing at least two materials, wherein one material is cross-linkable and the other is not crosslinkable, next applying the mixture to a substrate, and then removing at least one of the materials, for example by employing a solvent. Such single anti-reflective coatings, based on controlled surface structure, exhibit less angle-dependency of their optical properties. On the other hand, such coatings lack attractive mechanical robustness. This is especially relevant for films used in anti-reflective applications, as these are often very thin.

EP 1418448 A1 also discloses an anti-reflectance coating system that may be applied as a single layer while still having sufficient anti-reflective properties, but which provides the mechanical robustness of a hardcoat. In particular, EP 1418448 A1 discloses a single layer anti-reflective hard-coat that may be manufactured by a process comprising the steps of: (a) applying a mixture on a substrate, which mixture comprises a first material which does not crosslink and a second material which does crosslink, further in combination with nanoparticles, and optional solvent; (b) inducing crosslinking in the mixture applied to the substrate; and (c) subsequently removing at least part of the first material.

Such single anti-reflective coatings, based on controlled surface structure, exhibit less angle-dependency of their optical properties and also provide attractive hardcoat properties. However, the above-described single anti-reflective coatings have the disadvantage that, in order to obtain the desired surface structured, a two-step process is required, the first step to accomplish the coating and the second step to accomplish the formation of the structured surface and air voids by the removal of part of the coating material. This two-step process is not only economically impractical, but also can result in environmental contamination associated with the washing step.

### SUMMARY OF THE INVENTION

The present invention is directed to overcoming one or more of the problems set forth above. Briefly summarized, according to one aspect of the present invention, a multilayer optical film, for use in a display or component thereof, comprises a substrate having one or more functional layers, either adjacent or non-adjacent the substrate, wherein the topmost layer of the one or more functional layers, is an anti-reflective layer comprising elongated-shaped organically modified silica particles. The particles in the layer advantageously can form a nano-structured surface comprising nano-scale ridges and troughs (as observable by AFM or atomic force microscopy). The layer may also be characterized by interstitial porosity in which air voids are present, between the silica particles, below the surface of the nanoparticle. In one preferred embodiment, the anti-reflective layer is a silica-polymer nanocomposite further comprising a polymeric binder material.

Another aspect of the present invention relates to a method of forming such an anti-reflective layer, which method comprises coating, onto a substrate, a composition comprising (a) colloidal solution of elongated-shaped silica nanoparticles; (b) an optional polymer, oligomer, and/or monomer; (c) optional organic solvent, the silica nanoparticles being present in the coating composition in an amount from 1 to 99% by weight solids; and (d) drying the coating to remove organic solvent, thereby forming an anti-reflective polymer, optionally a silica-polymer nanocomposite film comprising a polymer binder.

In one embodiment, the elongated silica (SiO₂) nanoparticles are mixed with multi-functional organic monomer or oligomer and polymerization initiator. When coated onto a substrate, the composition is then polymerized, and the SiO₂ nanoparticles form a structured surface. The film is consequently porous, with an average refractive index lower than that of the components of the film, due to air between peaks in the structured surface.

In a preferred embodiment, the films can also serve as a hardcoat and will have a greater hardness than the substrate on which it is coated and a greater hardness than the polymer component alone, due to the presence of the silica.

In one particular embodiment, the use of a fluorinated oligomer can further reduce the average refractive index, yielding even lower reflectance. The use of the fluoro-oligomer can also provide a relatively low surface energy film with good resistance to penetration of contaminants into the porous film.

Anti-reflective films or coatings are herein defined as films or coatings that (when deposited onto a substrate) have a transmission higher than the transmission of the substrate in at least part of the visible light spectrum. Typically, such films are free or substantially free of structural features large enough to be capable of scattering visible light and such films should thus be essentially optically transparent.

Anti-reflection layers provide average specular reflectance values of less than 1% (as measured by a spectrophotometer and averaged over the wavelength range of 450 to 650 nm). In contrast, a low reflection layer provides an average specular reflectance of less than 2%, but not less than 1%.

In the framework of the present invention, the term “nanostructured surface” refers to a surface which exhibits nano-scale ridges and troughs that may be randomly distributed. More specifically, the height of the ridges (h) and the average distance (λC) between the ridges are (on average) in the micrometer to nanometer range. In a preferred embodiment suitable for anti-reflective applications, the height of the ridges (h) may be in the range of 50-200 nm and the lateral distance between ridges (λC) should be shorter than the shortest wavelengths of visible light (λ_{slight}), such as less than 400 nm. As used herein the term “nanoscale” refers to average dimensions of less than 500 nm, preferably less than 250 nm, more preferably less than 100 nm.

Similarly, any air voids within the layer, as a result of its interstitial voids or porosity, is nano-sized, preferably between 50 and 400 nm.

The coatings of the present invention have diverse applications, including anti-reflective hard coatings for automobile and airplane wind screens, cathode ray tubes (CRTs) such as used in televisions and computer monitors, flexible displays, and spectacles. The coatings according to the invention could advantageously be applied to any display application in general, including CRT, plasma, liquid-crystal, and OLED displays.

Anti-reflection films of the present invention are especially useful in polarizing plates that are components of displays such as LC (liquid crystal) displays, as a value-added coating for improving polarizer durability and performance. Such films according to the present invention can be used to provide reflectance below 1% over the visible spectrum and optionally hardcoat durability as well. The anti-reflective coatings according to the invention show less angle dependence of the anti-reflective performance in comparison to multilayer systems. Optionally, the anti-reflective coatings of the present invention advantageously may be applied to any optical systems where the anti-reflective coating is likely to be in contact with some sort of mechanical force, for example, where cleaning of the surface may periodically be required.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 shows one embodiment of a cover sheet composite comprising an anti-reflective film according to the present invention;

FIG. 2 shows a cross-sectional representation of a liquid crystal cell with polarizer plates on either side of the cell in accordance with the present invention;

FIG. 3 is an AFM (atomic force microscopy) image of bare TAC (tricellulose acetate) film without any coating in accordance with Comparative Example 5 below;

FIG. 4 is an AFM image of a 5-micrometer film of an acrylic polymer on a bare TAC film, without any nanoparticles, in accordance with Comparative Example 6 below;

FIG. 5 is an AFM image of 5-micrometer of an acrylic polymer with 30% spherical SiO₂ nanoparticles by weight, on bare TAC, in accordance with Comparative Example 7 below; and

FIG. 6 is an AFM image of a 5-micrometer film of an acrylic polymer admixed with 30% by weight elongated SiO₂ nanoparticles, on bare TAC, in accordance with the present invention as described in Example 1 below.

### DETAILED DESCRIPTION OF THE INVENTION

The invention has been described with reference to preferred embodiments. However, it will be appreciated that variations and modifications of such embodiments can be effected, by a person of ordinary skill in the art, without departing from the scope of the invention.

In the framework of this, invention the term “nanoparticles” is defined as particles of which the majority has a diameter of less than a micrometer, wherein diameter refers to the “equivalent circular diameter” (ECD) of the nanoparticle. For the elongated non-spherically shaped nanoparticles used in the present invention, the longest straight line that can be drawn from one side of a particle to the opposite side may be used as the value for the length, and the perpendicular dimension may be used as the value for the thickness or width of the elongated nanoparticle.

In a preferred embodiment, the majority of the nanoparticles have a diameter of less than 500 nm, more preferably the majority of particles have a diameter of less than 150 nm. Most preferably, all particles have a diameter smaller than 50 nm. The particles should have such a diameter that they do not significantly or unduly influence the transparency of the eventual coating. Processes for determining the particle diameter include BET adsorption, optical or scanning electron microscopy, or atomic force microscopy (AFM) imaging.

The term “equivalent circular diameter” (ECD), as used herein, means the diameter of a circle having the same projected area as a nanoparticle. This can be measured using known techniques. The term “aspect ratio” is used to define the ratio of nanoparticle ECD to nanoparticle thickness.

Alternately, the nanoparticles may be characterized by an elongation degree, as described in U.S. Pat. Nos. 5,597,512 and 5,221,497 to Watanabe et al., hereby both incorporated by reference in their entirety. The elongation degree of the nanoparticles is defined in terms of the size ratio D₁/D₂ wherein D₁ means the particle size in nm as measured by dynamic light-scattering method, explained in detail in Journal of Chemical Physics, Vol. 57, No. 11 (December, 1972), page 4814, which can be determined by the use of commercially available apparatus for dynamic light-scattering measurement. The particle size (D₂ nm) is calculated from the formula of D₂=2720/S (where S means a specific surface area (m²/g) of the particles to be measured by a conventional BET method (nitrogen gas-adsorbing method)), and means the diameter of the suppositional spherical colloidal silica particles having the same specific surface area S(m²/g) as that of the elongated colloidal silica particles. Accordingly, the ratio D₁/D₂ of the particle size (D₁ nm), as measured by the aforesaid dynamic light-scattering method, to the particle size (D₂ nm) as measured by the BET method represents the elongation degree of the elongated-shaped colloidal silica particles.

Preferably, the elongated silica particles used in the present invention is characterized by an aspect ratio or by an elongation degree (D₁/D₂ ratio) of 5 or more. The silica nanoparticles in the sol or colloidal solution used to make the coatings of the present invention have elongation in only one plane and a uniform thickness of from 5 to 20 nm along the elongation, preferably with a particle size D₁ of from 40 to 300 nm as measured by dynamic light-scattering method, or as observed by TEM electron microscopy, for a majority of the nanoparticles.

The elongated silica nanoparticles used in the present invention are organically modified by attaching an organic material to the surface of the nanoparticles. Preferably, the nanoparticles are organically modified with an alkoxy-silane-functional compound having an organic moiety, wherein the alkoxy-silane functionality is attached to the nanoparticle and the organic moiety extends from the surface to stabilize the nanoparticle. The alkoxy-silane functionality can also include substituted or unsubstituted alkyl groups. A preferred alkoxy-silane-functional compound is methacryloxypropyldimethyl ethoxysilane, commercially available from Aldrich Chemical Co. (PA).

In one embodiment, the organically modified nanoparticles are made by forming a solution comprising a silane coupling agent and a first organic solvent, slowly adding the solution to a nanoparticle dispersion in a second organic solvent at a temperature at which the first organic solvent (which has a relatively lower boiling point) is distilled out, gradually to yield an organically modified nanoparticle dispersion in the second organic solvent.

The preparation of silica nanoparticles as such is known in the art, and has been described in, for example, U.S. Pat. Nos. 5,221,497 and 5,597,512, cited above. Such materials are commercially available from Nissan Chemical Industries, Ltd. (Tokyo, Japan). In some cases, the silica particles may optionally contain a slight amount of the oxides of other polyvalent metals. The concentration of such optional additional oxides of a polyvalent metal is, for example, 1500 to 15000 ppm in total to SiO₂ as a weight ratio in the silica sol used to form the particles. Such other polyvalent metals include divalent metals such as calcium (Ca), magnesium (Mg), strontium (Sr), barium (Ba), zinc (Zn), tin (Sn), lead (Pb), copper (Cu), iron (Fe), nickel (Ni), cobalt (Co), and manganese (Mn); trivalent metals such as aluminum (Al), iron (Fe), chromium (Cr), yttrium (Y), and titanium (Ti); and quadrivalent metals such as Ti, Zn, and Sn.

The nanoparticles used in the process according to the invention are often provided in the form of a suspension. The anti-reflective layer of the present invention can be made by coating a colloidal solution of elongated-shaped silica particles in which the silica particles are present in the layer in an amount from 1 to 99% by weight solids, preferably in an amount from 5 to 95 weight %, more preferably from 15 to 90 weight %.

In the process according to the present invention, a polymer binder material is optionally used, which polymer may or may not be crosslinked. In principle, a wide variety of materials are suitable to be used as the binder material. However, the combination of the binder material and all other materials should advantageously result in a homogenous mixture.

Alternatively, instead of, or in addition to, a separate binder material, the nanoparticle stabilizer, used to organically modify the polymer, may be crosslinked to provide mechanical durability to the layer.

The polymer can be obtained by using a pre-formed polymer (including polymerizable oligomers) or by using monomers that are polymerized in the coating composition. In one preferred embodiment, the binder material is a polymer that is homogenously mixed with the nanoparticles to for the coating composition. The final polymer, if not crosslinked, preferably has a weight average molecular weight of 500 to 10⁶, more preferably 1000 to 10⁶.

As indicated above, a wide variety of polymers are in principle suitable as a binder material in the final anti-reflective layer. These polymers include all those made from condensation polymerization such as polycarbonates, polyesters, polysulfones, polyurethane-based resins, polymer amides, and polymer imides; and those made from addition polymerization such as polyacrylics, polystyrenes, polyolefins, polycycloolefins, and polyethers, as well as naturally derived polymers such as cellulose acetates. Preferably, the polymer in the coating penetrates into the underlying substrate to promote adhesion of he anti-reflective layer. In general, lower molecular weight polymers provide more penetration. Also, a slower coating process tends to promote penetration. During the coating process, a solvent may be selected that can diffuse into the substrate, swelling the substrate to some extent, permitting or enhancing polymer penetration into the substrate.

Optionally, the polymer, oligomer, or monomer in the coating composition for the anti-reflective coating may be cross-linked. Any crosslinking method is suitable to be used in the process according to the invention. Suitable ways to initiate crosslinking are for example electron beam radiation, electromagnetic radiation (UV, Visible and Near IR), thermally, and by adding moisture, in case moisture curable compounds.

In one preferred embodiment, the polymer binder is crosslinked by UV-radiation. UV-crosslinking may take place through a free radical mechanism or by a cationic mechanism, or a combination thereof. In another preferred embodiment the crosslinking is achieved thermally.

Acrylate monomers (reactive diluents) and oligomers (reactive resins and lacquers) are the primary components of the free radical based formulations, giving the cured coating most of its physical characteristics. Photo-initiators are required to absorb the UV light energy, decompose to form free radicals, and attack the acrylate group C=C double bond to initiate polymerization. Cationic chemistry utilizes cycloaliphatic epoxy resins and vinyl ether monomers as the primary components. Photo-initiators absorb the UV light to form a Lewis acid, which attacks the epoxy ring initiating polymerization. By UV-curing is meant ultraviolet curing and involves the use of UV radiation of wavelengths between 280 and 420 nm preferably between 320 and 410 nm.

Examples of UV radiation curable resins and lacquers usable for the anti-reflection layer include those derived from photo polymerizable monomers and oligomers such as acrylate and methacrylate oligomers (the term “(meth)acrylate” used herein refers to acrylate and methacrylate), of polyfunctional compounds, such as polyhydric alcohols and their derivatives having (meth)acrylate functional groups such as ethoxylated trimethylolpropane tri(meth)acrylate, tripropylene glycol di(meth)acrylate, trimethylolpropane tri(meth)acrylate, diethylene glycol di(meth)acrylate, pentaerythritol tetra(meth)acrylate, pentaerythritol tri(meth)acrylate, dipentaerythritol hexa(meth)acrylate, 1,6-hexanediol di(meth)acrylate, or neopentyl glycol di(meth)acrylate and mixtures thereof, and acrylate and methacrylate oligomers derived from low-molecular weight polyester resin, polyether resin, epoxy resin, polyurethane resin, alkyd resin, spiroacetal resin, epoxy acrylates, polybutadiene resin, and polythiol-polyene resin, and the like and mixtures thereof, and ionizing radiation-curable resins containing a relatively large amount of a reactive diluent. Reactive diluents usable herein include monofunctional monomers, such as ethyl (meth)acrylate, ethylhexyl (meth)acrylate, styrene, vinyltoluene, and N-vinylpyrrolidone, and polyfunctional monomers, for example, trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, or neopentyl glycol di(meth)acrylate.

Among others, for use in the present invention, conveniently used radiation-curable lacquers include urethane (meth)acrylate oligomers. These are derived from reacting diisocyanates with an oligo(poly)ester or oligo(poly)ether polyol to yield an isocyanate terminated urethane. Subsequently, hydroxy terminated acrylates are reacted with the terminal isocyanate groups. This acrylation provides the unsaturation to the ends of the oligomer. The aliphatic or aromatic nature of the urethane acrylate is determined by the choice of diisocyanates. An aromatic diisocyanate, such as toluene diisocyanate, will yield an aromatic urethane acrylate oligomer. An aliphatic urethane acrylate will result from the selection of an aliphatic diisocyanate, such as isophorone diisocyanate or hexyl methyl diisocyanate. Polyols are generally classified as esters, ethers, or a combination of these two. The oligomer backbone of the polyol is terminated by two or more acrylate or methacrylate units, which serve as reactive sites for free radical initiated polymerization. Choices among isocyanates, polyols, and acrylate or methacrylate termination units allow considerable latitude in the development of urethane acrylate oligomers. These oligomers are multifunctional and contain multiple reactive sites. Because of the increased number of reactive sites, the cure rate is improved and the final product is cross-linked. The oligomer functionality can vary from 2 to 6.

Among others, conveniently used radiation-curable resins include polyfunctional acrylic compounds derived from polyhydric alcohols and their derivatives such as mixtures of acrylate derivatives of pentaerythritol such as pentaerythritol tetraacrylate and pentaerythritol triacrylate functionalized aliphatic urethanes derived from isophorone diisocyanate. Some examples of urethane acrylate oligomers that can be used in the practice of this invention, which are commercially available include oligomers from Sartomer Company (Exton, Pa.). An example of a resin that is conveniently used in the practice of this invention is CN 968 from Sartomer Company.

An initiator may be present in the coating composition to initiate a crosslinking reaction. A photo-initiator is capable of initiating a crosslinking reaction upon absorption of light. Thus, UV- photo-initiators absorb light in the Ultra-Violet region of the spectrum. Any suitable known UV-photo-initiators may be used in the process according to the invention. A photo polymerization initiator, such as an acetophenone compound, a benzophenone compound, Michler's benzoyl benzoate, α-amyloxime ester, or a thioxanthone compound and a photosensitizer such as n-butyl amine, triethylamine, or tri-n-butyl phosphine, or a mixture thereof, can be incorporated in the ultraviolet radiation curing composition. In the present invention, conveniently used initiators are 1-hydroxycyclohexyl phenyl ketone and 2-methyl-1-[4-(methyl thio) phenyl]-2-morpholinopropanone-1.

The UV polymerizable monomers and oligomers are coated and dried, and subsequently exposed to UV radiation to form an optically clear cross-linked layer. The preferred UV cure dosage is between 50 and 1000 mJ/cm². The amount of initiator may vary between wide ranges. A suitable amount of photo-initiator is, for example, between above 0 and 20 wt % with respect to total weight of the compounds that take part in the crosslinking reaction. The relative amount of photo-initiator will determine the kinetics of the crosslinking step and can thus be used to affect the (nano) surface structure and thus the anti-reflective performance.

A UV-curable coating composition can be made, for example, as follows. A UV-curable monomer or oligomer or polymer in a solvent is placed on a stirring device. To this mixture is added photo initiator. After stirring for certain period of time, the organically modified nanoparticles, dispersed in another solvent, is added drop-wise to the mix. The resulting mixture has sufficiently low viscosity that it could be micro pumped through a moving X-hopper and applied to a plastic film substrate. The coated substrate can then be dried and exposed to UV lamp to complete curing. The thickness of the coated film can be controlled by various process factors such as solvent, coverage, concentration, and so on.

Alternatively, non-UV curing polymers may be used in the anti-reflection layer. For example, in another embodiment, preferred polymers are fluorine-containing homopolymers or copolymers having a refractive index of less than 1.48, preferably with a refractive index between about 1.35 and 1.40. Suitable fluorine-containing homopolymers and copolymers include: fluoro-olefins (for example, fluoroethylene, vinylidene fluoride, tetrafluoroethylene, hexafluoroethylene, hexafluoropropylene, perfluoro-2,2-dimethyl-1,3-dioxol), partially or completely fluorinated alkyl ester derivatives of (meth)acrylic acid, and completely or partially fluorinated vinyl ethers, copolymers based on fluoroethylenes and vinyl ethers and the like.

Preferred polymer binders are polyacrylics such as polymethacrylic-based resins, either crosslinked or uncrosslinked, and either preformed or formed in-situ from a monomer mixture. Methacrylic oligomers such as SANTOMER monomers, mentioned above. Other preferred binder materials are fluoropolymers such as LUMIFLON commercially available from Asahi Chemical Co. (Tokyo, Japan). Still another preferred binder materials are the naturally derived cellulose acetates such as acetate butyrate cellulose.

A wide variety of substrates may be used as a substrate in the process according to the invention. Suitable substrates are, for example, flat or curved, rigid or flexible substrates. Such substrates include films of, for example, polycarbonate, polyester, polyvinyl acetate, polyvinyl pyrollidone, polyvinyl chloride, polyimide, polyethylene naphthalate, polytetrafluoro ethylene, nylon, polynorbomene or amorphous solids, for example glass or crystalline materials, such as for example silicon or gallium arsenide. Preferred substrates for use in display applications are, for example, glass, polynorbornene, polyethersulfone, polyethyleneterephthalate, polyimide, cellulose triacetate, polycarbonate and polyethylenenaphthalate.

As mentioned above, another aspect of the invention relates to a method of forming an anti-reflective layer, which method comprises coating, onto a substrate, a coating composition comprising (a) a colloidal solution of elongated-shaped organically modified silica nanoparticles; (b) an optional polymer material or oligomeric or monomeric precursor thereof; (c) optional organic solvent (which can be replaced, for example, by monomers), the silica nanoparticles being present in the coating composition in an amount from 1 to 99% by weight solids, more preferably from 15 to 90 weight % solids; and (d) drying the coating to remove organic solvent, thereby forming the anti-reflective layer, preferably a silica-polymer nanocomposite film. An anti-reflection layer having a nano-structured surface comprising nano-scale ridges and troughs can be thus formed, which may also further comprise air voids below the nano-structured surface, whereby the layer is characterized by interstitial porosity formed by the space between particles.

The mixture may be applied onto a substrate by any process known in the art of wet coating deposition. Examples of suitable processes are spin coating, dip coating, spray coating, flow coating, meniscus coating, capillary coating, and roll coating.

In principle, it is possible to apply the coating mixture to the substrate without the use of a solvent, for example by using nanoparticles and mixing them into a liquid mixture of the other components, for example, liquid monomer. However, typically, the polymer or monomer and the nanoparticles are mixed with at least one solvent to prepare a mixture that is suitable for application to the substrate using the chosen method of application.

In principle, a wide variety of solvents may be used. However, the combination of the solvents and all other materials present in the mixture should advantageously result in a homogenous mixture.

Nanoparticles typically are added to the mixture in the form of a colloidal suspension. The same solvent may be used to adjust the mixture so that it has the desired properties. However, other solvents may also be used

Examples of solvents that may be suitable are 1,4- dioxane, acetone, acetonitrile, chloroform, chlorophenol, cyclohexane, cyclohexanone, cyclopentanone, dichloromethane, diethyl acetate, diethyl ketone, dimethyl carbonate, dimethylformamide, dimethylsulphoxide, ethanol, ethyl acetate, m-cresol, mono- and di-alkyl substituted glycols, N,N-dimethylacetamide, p-chlorophenol, 1,2-propanediol, 1-pentanol, 1-propanol, 2-hexanone, 2-methoxyethanol, 2-methyl-2-propanol, 2-octanone, 2-propanol, 3-pentanone, 4-methyl-2-pentanone, hexafluoroisopropanol, methanol, methyl acetate, n-propyl acetate, methyl acetoacetate, methyl ethyl ketone, methyl propyl ketone, n-methylpyrrolidone-2, n-pentyl acetate, phenol, tetrafluoro-n-propanol, tetrafluoroisopropanol, tetrahydrofuran, toluene, xylene and water. Alcohols, ketones and esters based solvents may also be used, although the solubility of acrylates may become an issue with high molecular weight alcohols. Halogenated solvents (such as dichloromethane and chloroform) and hydrocarbons (such as hexanes and cyclohexanes) may also be suitable. Generally, to enhance adhesion of the low-reflection layer to the substrate, the solvent can be selected for the particular substrate to enhance adhesion. For example, when using a cellulose acetate substrate, n-propyl acetate is a preferred solvent.

Any other suitable additive may be added to the films or coatings according to the invention. It remains, however, advantageous that the mixture is homogenous prior to coating.

After applying the coating composition, washing is not necessary to obtain voids. Thus, a nano-structured surface can be obtained in a one-step coating process. Without wishing to be bound by theory, it is believed that the elongated silica nanoparticles are anisotropically assembled in the coating as it is dried, so that the particles become vertically aligned to some extent in forming the ridges and troughs in the anti-reflectance layer. In addition, pores may be formed during the evaporation of the organic solvent from the nanoparticle and/or its penetration into the underlying substrate.

The thickness of the anti-reflection layer is generally about 50 nm to 10 micrometers preferably 100 to 800 nanometers, more preferably 100 to 200 nanometers.

The anti-reflective layer is preferably colorless, but it is specifically contemplated that this layer can have some color for the purposes of color correction, or for special effects, so long as it does not detrimentally affect the formation or viewing of the display through the overcoat. Thus, there can be incorporated into the coating composition, for the anti-reflective layer, dyes that will impart color. In addition, additives can be incorporated into the polymer that will give desired properties to the layer. Additional compounds include surfactants, emulsifiers, coating aids, lubricants, matte particles, rheology modifiers, crosslinking agents, antifoggants, inorganic fillers such as conductive and nonconductive metal oxide particles, pigments, magnetic particles, biocides, and the like.

The effectiveness of the layer may be improved by the incorporation of additional submicron-sized inorganic particles or polymer particles that can induce interstitial air voids within the coating. This technique is further described in U.S. Pat. No. 6,210,858 and U.S. Pat. No. 5,919,555. Further improvement in the effectiveness of the low reflection layer may be realized with air voids in the internal particle space of submicron-sized polymer particles with reduced coating haze penalty, as described in commonly assigned U.S. patent application 10/715,655, filed Nov. 18, 2003.

The composition of the coating composition for the anti-reflective layer, as well as the process chosen, including the various steps and the exact process conditions of the steps in the process, will together determine the surface structure of the anti-reflective film or coating obtained. The surface structure (i.e. the depth of the troughs and distance between ridges) is, for example, affected by temperature, nanoparticle loadings, the nature of the nanoparticles and the organic binder, the solvent, the UV-curing process, etc. For example, a finer nano-structure (voids and ridges sufficiently small) and a lower density of the coating tend to produce lower reflection or lower scatter. Also, a slower coating process tends to produce and thinner and finer structure. The refractive index “n” is controlled by the void density and anti-reflection property by both the effective refractive index and the effective thickness of the layer.

The mechanical properties of the film or coating may also be affected by the chosen methods and conditions. For example, the crosslink density of any crosslinking may be increased by heating the film or coating during or after crosslinking. By increasing the crosslink density of the film, the hardness, the modulus, and the Tg of the resulting film or coating may be increased.

In general, the coatings according to the invention have a refractive index value of 1.1 to 1.4, preferably 1.2 to 1.3, as calculated based on reflectance, depending on porosity or degree of air void in the layer.

In a preferred embodiment of the invention, the anti-reflective film according to the invention comprises a majority of the ridges that are smaller than 300 nm, preferably less than 150 nm, depending on the application. A useful way to characterize the surface structure is by using AFM (atomic force microscopy) imaging and TEM (transmission electron microscopy). In one embodiment of the invention, the RMS surface roughness of the anti-reflective film is 2 to 15, preferably 5 to 10. In a preferred embodiment, the nano-structured films or coatings according to the invention do not reduce the optical transmission characteristics of a substrate on which they are present to visible wavelengths of the electromagnetic spectrum.

In another preferred embodiment, the nano-structured films or coatings according to the invention increases the optical transmission of a substrate on which they are present to visible wavelengths of the electromagnetic spectrum.

Multilayer optical films according to the present invention are useful as cover sheets that are used in the fabrication of polarizer plates for liquid crystal displays. In addition to the anti-reflective film, suitable auxiliary functional layers for use in the multilayer films of the present invention include, for example, an abrasion resistant hardcoat layer, antiglare layer, anti-smudge layer, stain-resistant layer, low reflection layer, antistatic layer, viewing angle compensation layer, and moisture barrier layer. Optionally, such a cover sheet composite of the invention can also comprises a strippable, protection layer on the topside of the cover sheet.

In one embodiment, such cover sheets can, for example, comprise a composite sheet comprising an optional carrier substrate, a low birefringence polymer film, a layer promoting adhesion to PVA, and at least one auxiliary (functional) layers, in addition to the anti-reflective film, on the same side of said carrier substrate as the low birefringence polymer film.

Low birefringence polymer films suitable for use in covers sheets comprise polymeric materials having low Intrinsic Birefringence Δnᵢₙₜ that form high clarity films with high light transmission (i.e., >85%). Preferably, the low birefringence polymer film has in-plane birefringence, Δnᵢₙ of less than about 1×10⁻⁴ and an out-of-plane birefringence, Δnₜₕ of from 0.005 to −0.005. Exemplary polymeric materials for use in the low birefringence polymer films of the invention include cellulose esters (including triacetyl cellulose (TAC), cellulose diacetate, cellulose acetate butyrate, cellulose acetate propionate), polycarbonates (such as LEXAN available from General Electric Corp.), polysulfones (such as UDEL available from Amoco Performance Products Inc.), polyacrylates, and cyclic olefin polymers (such as ARTON available from JSR Corp., ZEONEX and ZEONOR available from Nippon Zeon, TOPAS supplied by Ticona), among others. Preferably, the low birefringence polymer film (substrate in the multilayer optical film) comprises TAC, polycarbonate, or cyclic olefin polymers due their commercial availability and excellent optical properties.

The low birefringence polymer film can have a thickness from about 5 to 100 micrometers, preferably from about 5 to 50 micrometers, and most preferably from about 10 to 40 micrometers.

Liquid Crystal Displays typically employ two polarizer plates, one on each side of the liquid crystal cell. Each polarizer plate, in turn, employs two cover sheets, one on each side of the PVA-dichroic film. Each cover sheet may have various auxiliary layers that are necessary to improve the performance of the Liquid Crystal Display. Useful auxiliary layers employed in cover sheets include those mentioned above. Typically, the cover sheet closest to the viewer contains one or more of the following auxiliary layers: the abrasion resistant layer, anti-smudge or stain-resistant layer, anti-reflection layer, and antiglare layer. One or both of the cover sheets closest to the liquid crystal cell typically contain a viewing angle compensation layer. Any or all of the four cover sheets employed in the LCD may optionally contain an antistatic layer and a moisture barrier layer.

In one particular embodiment, a cover sheet composite contains an antiglare layer in addition to an anti-reflection layer. Preferably, the antiglare layer and anti-reflection layer are located on the front side of the low birefringence polymer film opposite to the polarizing film in a polarizer plate.

An antiglare coating provides a roughened or textured surface that is used to reduce specular reflection. All of the unwanted reflected light is still present, but it is scattered rather than specularly reflected. In another embodiment of the present invention, an anti-reflection layer according to the present invention is used in combination with an abrasion resistant hard coat layer and/or antiglare layer. The anti-reflection coating is applied on top of the antiglare layer or abrasion resistant layer or both.

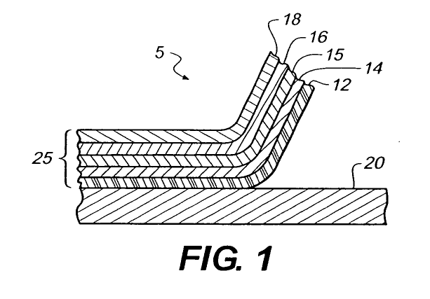

For example, FIG. 1 shows one embodiment of a cover sheet composite 5 comprising cover sheet 25 that is comprised of a lowermost layer 12 nearest to a carrier substrate 20, three intermediate functional layers 14, 15, and 16, and an uppermost layer 18, being peeled from a carrier substrate 20 prior to adhesion to a polarizing film in the manufacture of a polarizing plate. In this illustration, layer 12 is a layer promoting adhesion to the poly(vinylalcohol)-containing polarizing film, layer 14 is a low birefringence protective polymer film, layer 15 is a moisture barrier layer, layer 16 is an antiglare layer, and layer 18 is an anti-reflection layer according to the present invention.

The auxiliary layers can be applied by any of a number of well known liquid coating techniques, such as dip coating, rod coating, blade coating, air knife coating, gravure coating, microgravure coating, reverse roll coating, slot coating, extrusion coating, slide coating, curtain coating, or by vacuum deposition techniques. In the case of liquid coating, the wet layer is generally dried by simple evaporation, which may be accelerated by known techniques such as convection heating. The auxiliary layer may be applied simultaneously with other layers such as subbing layers and the low birefringence polymer film. Several different auxiliary layers may be coated simultaneously using slide coating, for example, an antistatic layer may be coated simultaneously with a moisture barrier layer or a moisture barrier layer may be coated simultaneously with a viewing angle compensation layer. Known coating and drying methods are described in further detail in Research Disclosure 308119, Published Dec. 1989, pp. 1007 to 1008.

The multilayer optical films of the present invention are useful as cover sheets with a wide variety of LCD display modes, for example, Twisted Nematic (TN), Super Twisted Nematic (STN), Optically Compensated Bend (OCB), In Plane Switching (IPS), or Vertically Aligned (VA) liquid crystal displays. These various liquid crystal display technologies have been reviewed in U.S. Pat. Nos. 5,619,352 (Koch et al.), 5,410,422 (Bos), and 4,701,028 (Clerc et al.).

As should be obvious based on the preceding detailed description, a wide variety of guarded cover sheet composites having various types and arrangements of auxiliary layers may be prepared. Some of the configurations possible in accordance with the present invention are illustrated in USSN 11/028,036, Filed Jan. 03, 2005, hereby incorporated by reference. The latter application also discloses a method to fabricate a polarizer plate from guarded cover sheet composites, in which the cover sheet is laminated to the PVA dichroic polarizing film such that the layer promoting adhesion to PVA is on the side of the cover sheet that contacts the PVA dichroic film. A glue solution may be used for laminating the cover film and the PVA dichroic film

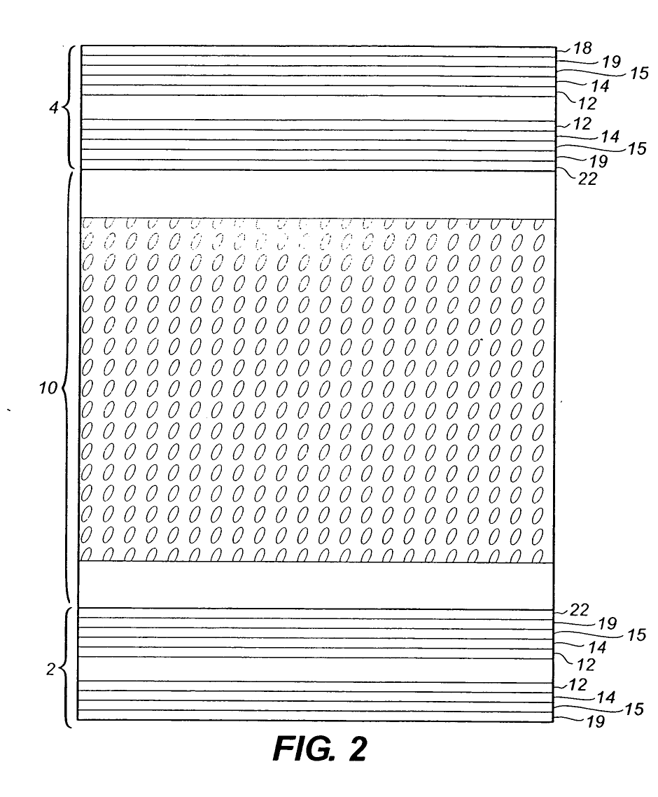

FIG. 2 presents a cross-sectional illustration showing a liquid crystal cell 10 having polarizer plates 2 and 4 disposed on either side. Polarizer plate 4 is on the side of the LCD cell closest to the viewer. Each polarizer plate employs two cover sheets. For the purpose of illustration, polarizer plate 4 is shown with an uppermost cover sheet (this is the cover sheet closest to the viewer) comprising a layer promoting adhesion to PVA 12, low birefringence polymer film 14, moisture barrier layer 15, antistatic layer 19, and anti-reflection layer 18. The lowermost cover sheet contained in polarizer plate 4 comprises a layer promoting adhesion to PVA 12, low birefringence polymer film 14, moisture barrier layer 15, antistatic layer 19, and viewing angle compensation layer 22. On the opposite side of the LCD cell, polarizer plate 2 is shown with an uppermost cover sheet, which for the purpose of illustration, comprises a layer promoting adhesion to PVA 12, low birefringence polymer film 14, moisture barrier layer 15, antistatic layer 19, and viewing angle compensation layer 22. Polarizer plate 2 also has a lowermost cover sheet comprising a layer promoting adhesion to PVA 12, low birefringence polymer film 14, moisture barrier layer 15, and antistatic layer 19.

### EXAMPLES

A. Synthesis of Organically Modified Nanoparticles

In this example, a solution comprising a silane coupling agent and a first solvent was added slowly to a nanoparticle dispersion in a second solvent at a certain temperature at which the first solvent with a lower boiling point is distilled out gradually, thereby yielding an organically modified nanoparticle dispersion in the second solvent. In particular, methacryloxypropyl dimethylethoxysilane-functionalized elongated SiO₂ nanoparticles in propyl acetate was prepared as follows.

A dispersion comprising 100 grams of 20 wt % elongated SiO₂ nanoparticle (10 to 50 nm average diameter) dispersed in methanol that was purchased from Nissan Chemicals, known as MA-ST-UP, was charged into a 500 ml three-neck round bottom flask equipped with an addition funnel, distillation condenser, and a magnetic stir bar. When the dispersion started refluxing, a solution containing 4.5 grams of methacryloxypropyldimethyl ethoxysilane (Aldrich) and 100 ml of propyl acetate was drop-by-drop added to the nano-SiO₂ methanol dispersion. When almost no methanol could be distillated out at ca. 65° C., a new dispersion of 22 wt % methacryloxypropyl dimethylethoxysilane functionalized-SiO₂ nanoparticles in propyl acetate was collected.

B. Measurement of Reflectance

Percent (%) Reflectance is measured using standard software supplied with a Perkin Elmer LAMBDA 800 UV/Vis Spectrophotometer equipped with a 60 mm integrating sphere attachment. The instrument is baseline corrected using a SPECTRALON standard. Scans of the samples are made from 200 to 900 nm with 1 nm resolution using a 2 nm wide slit.

C. Preparation of Anti-reflective Films and Properties

### EXAMPLES 1-4

A UV-curable monomer in a solvent was placed on a small-prop stirring device. To this mixture was added photo-initiator. After stirring for certain period of time, organically modified nanoparticles dispersed in another solvent was added drop wise to the mix. The resulting mixture has sufficiently low viscosity that it could be micro pumped through a moving X-hopper and applied to plastic film substrate. The coated substrate was dried and expose to a UV lamp to complete curing. The thickness of the coated film can be controlled by different experimental factors such as solvent, coverage, concentration, and so on, and can be measured by transmission electron microscopy (TEM).

In particular, for Example 1, a composition comprising 11.37 grams of a 6.94% solids solution of SARTOMER CN968 (UV curable oligomer) in n-propylacetate was placed on a small prop-stirring device at 1200 rpm. To this mixture was added 0.316 grams of a 5% solution of CIBA IRGACURE 184 photo-initiator in n-propylacetate. After stirring 5 min, 3.31 grams of a 10.2% dispersion of modified elongated silica in n-propylacetate was added drop wise to the mix. The resulting 7.6% solids mixture has sufficiently low viscosity such that it could be micro pumped through a moving X-hopper and applied at 1.5 cc/ft² (16.15 cc/m²) to a statically held cellulose triacetate substrate. The coated substrate was dried in an 29.4° C. laminar-flow hood for 5 min prior to 1.6 mJoules of H-bulb UV-exposure for complete curing.

In Examples 2-4, the coating process is similar to Example 1, except that different coverages of coating (in Examples 2 and 3) or a different ratio of elongated SiO₂ to monomer (Example 4) was used.

### COMPARATIVE EXAMPLES 5, 6, and 8

Comparative Example 5 consisted of a TAC film without any coating, neither polymer binder nor nanoparticles.

Comparative Example 6 consisted of a UV-cured polymer film without nanoparticles of silica. The composition for the polymer film comprised 14.55 grams of 7.75% solution of SARTOMER CN968 monomer in propylacetate, which composition was placed on a small prop-stirring device at 1200 rpm. Then, 0.45 grams of a 5% solution of CIBA IRGACURE 184 initiator in propylacetate solvent was added drop wise. Stirring was continued for 5 min. The resulting 7.66% solids solution was micro pumped thru a moving X-hopper and applied at 1.5 cc/ft² (16.15 cc/m²) to a statically held cellulose triacetate substrate. The coated substrate was dried in an 85° F. (29.4° C.) laminar-flow hood for 5 min prior to 1.6 mJoules of H-bulb UV-exposure for complete curing. The resulting dry coverage was 102 mg/ft² (1098 mg/m²).

Comparative Example 8 consisted of a UV-cured polymer film without nanoparticles of silica, as in Example 7, except using a different coverage.

### COMPARATIVE EXAMPLE 7

This Comparative Example 7 illustrates the making of a UV-cured anti-reflective film by using organically modified spherical silica (S-SiO₂) instead of elongated silica (E-SiO₂). A composition comprising 12.784 grams of a 6.2% solids solution of SARTOMER CN968 monomer in propylacetate solvent was placed on a small prop-stirring device at 1200 rpm. Then, 0.32 grams of 5% CIBA IRGACURE 184 initiator in propylacetate was added drop wise. Stirring was continued for 5 min. A composition comprising 1.9 grams of a 17.8% dispersion of modified spherical silica in propylacetate solvent was added, drop-wise to the mix. The resulting 7.6% solids mixture had sufficiently low viscosity such that it could be micro pumped through a moving X-hopper and applied at 1.5 cc/ft² (16.15 cc/m²) to a statically held cellulose triacetate substrate. The coated substrate was dried at 85° F. (29.4 °C.) in a laminar-flow hood for 5 min prior to 1.6 mJoules of H-bulb UV-exposure to complete curing. The resulting dry coverage was 101.4 mg/ft² (1091.5 mg/m²)

As described above, % Reflectance was measured using standard software supplied with a Perkin Elmer LAMBDA 800 UV/Vis Spectrophotometer. Prior to measurement the individual samples were blackened on the non-coated side to minimize the second surface reflection. The total reflection results are shown in Tables 1 below. Table 2 shows the effect of coverage on total reflectance.

TABLE 1*

| | | SiO₂, mg/ft² | SARTOMER CN968, | % Total Reflectance | | |
|---|---|---|---|---|---|---|
| Coating System | Nanoparticle | (mg/m²) | mg/ft² (mg/m²) | 400 nm | 550 nm | 800 nm |
| Example 1 | E- SiO₂ | 150 (1614.5) | 350 (3767.4) | 6.9 | 7.0 | 7.1 |
| Comparative Example 5 | No | 0 | 0 | 8.0 | 7.8 | 7.4 |
| Comparative Example 6 | No | 0 | 500 (5382) | 8.4 | 7.9 | 7.5 |
| Comparative Example 7 | S—SiO₂ | 150 (1614.5) | 350 (3767.4) | 7.9 | 7.7 | 7.3 |

*without black paint on back.

TABLE 2*

| | | | Sartomer ® | % Total | | |
|---|---|---|---|---|---|---|
| | | SiO₂, | CN968, | Reflectance | | |
| Coating | Nano- | mg/ft² | mg/ft² | 400 | 550 | 800 |
| System | particle | (mg/m²) | (mg/m²) | nm | nm | nm |
| Example 2 | E- SiO₂ | 30 | 70 | 3.2 | 3.0 | 4.8 |
| | | (323) | (753.5) | | | |
| Example 3 | E- SiO₂ | 15 | 35 | 4.7 | 1.7 | 2.3 |
| | | (161.5) | (376.7) | | | |
| Example 4 | E- SiO₂ | 12 | 28 | 2.6 | 2.7 | 1.7 |
| | | (129.2) | (301.4) | | | |
| Comparative | — | — | 28 | 5.1 | 5.2 | 5.0 |
| Example 8 | | | (301.4) | | | |

*with black painted back.

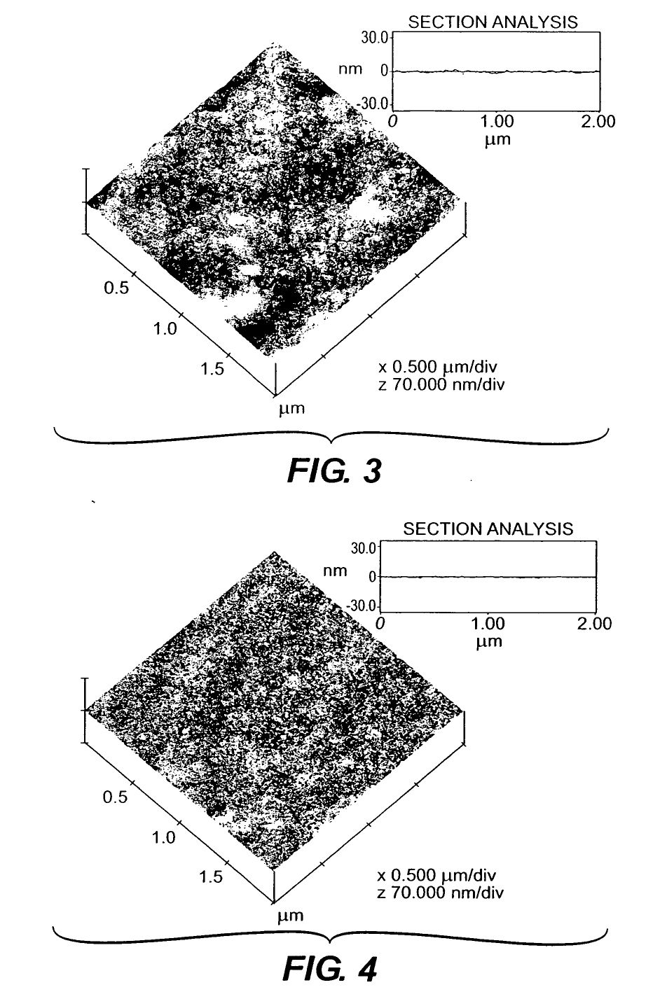

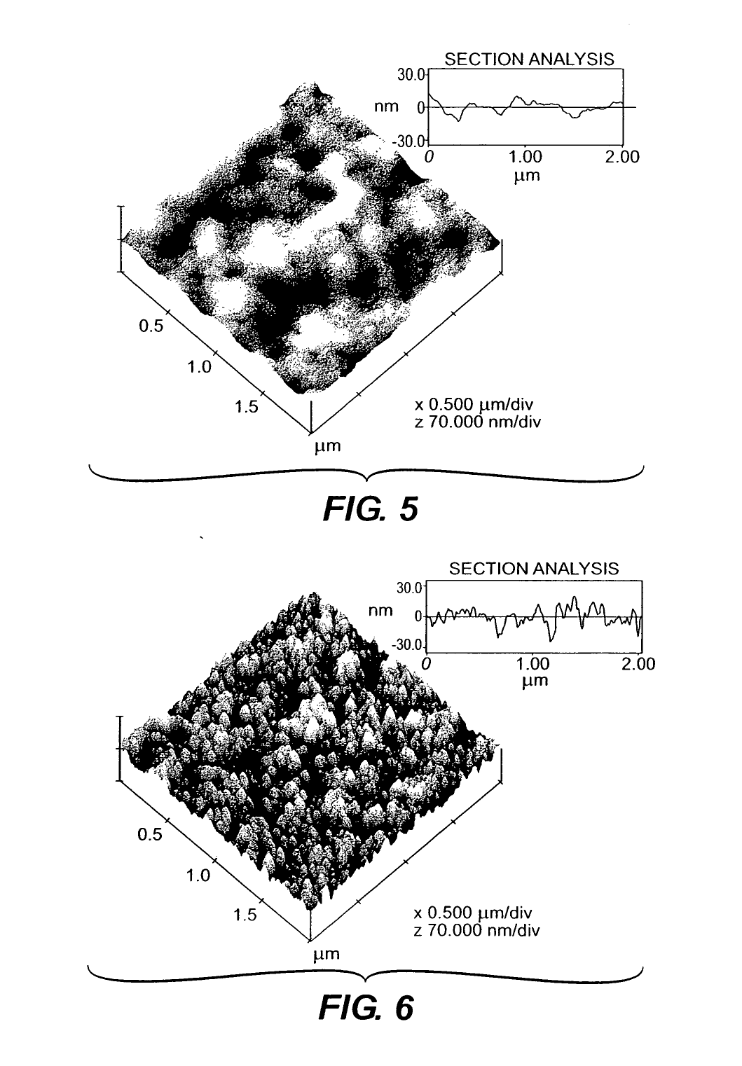

FIG. 3 is an AFM (atomic force microscopy) image of bare TAC film without any coating in accordance with Comparative Example 5 above; FIG. 4 is an AFM image of a 5-micrometer film (calculated based on solid coverage) of an acrylic polymer on a bare TAC film without any nanoparticles in accordance with Comparative Example 6 above; FIG. 5 is an AFM image of a 5-micrometer film of an acrylic polymer with spherical nanoparticles, on bare TAC, in accordance with Comparative Example 7; and FIG. 6 is an AFM image of a 5-micrometer film of an acrylic polymer with elongated nanoparticles, on bare TAC, in accordance with the present invention as described in Example 1 above.

Based on the results shown above, it is clear that both bare TAC and monomer-coated TAC showed a very smooth surface. The surface coatings with spherical silica and elongated silica give rough surfaces, but the size of the surface structure is much larger with spherical silica than with elongated silica.

### EXAMPLES 9, 10, and 11

This Example illustrates the preparation of a nano-structured anti-reflective film comprising organically modified elongated nanoparticles of SiO₂ and LUMIFLON fluorinated polymer.

For Example 9, a composition comprising 11.62 grams of a 6.8% solids solution of LUMIFLON polymer in n-propylacetate was placed on small prop stirring device at 1200 rpm. Then, 3.38 grams of a 10% dispersion of modified elongated silica in n-propylacetate was added drop wise to the mix. The resulting 7.5% solids mixture was micro pumped through a moving X-hopper and applied at 1.5 cc/ft² (16.15 cc/m²) to a static held cellulose triacetate substrate. The coated substrate was dried in an 85° F. (29.4° C.) laminar-flow hood for 5 min.

For Example 10, the anti-reflection layer was generated in a similar way to that in Example 9 except using different solid coverage.

For Comparative Example 11, a coated layer was generated in a similar way to that in Example 9 except using spherical silica nanoparticle.

TABLE 3

| | | SiO₂, | Lumiflon ® | % Reflectance | | |
|---|---|---|---|---|---|---|
| Coating | Nano- | mg/ft² | mg/ft² | 400 | 550 | 800 |
| System | particle | (mg/m²) | (mg/m²) | nm | nm | nm |
| Example 9 | E- SiO₂ | 10 | 10 | 2.3 | 2.1 | 2.5 |
| | | (107.6) | (107.6) | | | |
| Example 10 | E- SiO₂ | 25 | 25 | 2.5 | 3.5 | 2.7 |
| | | (269.1) | (269.1) | | | |
| Comparable | — | — | 50 | 4.4 | 4.5 | 4.4 |
| Example 6 | | | (538.2) | | | |
| Comparable | S—SiO₂ | 25 | 25 | 3.8 | 3.9 | 3.8 |
| Example 11 | | (269.1) | (269.1) | | | |

Parts List

2 polarizer plate

4 polarizer plate

5 cover sheet composite

10 liquid crystal cell

12 layer promoting adhesion

14 low birefringence protective film

15 moisture barrier layer

16 functional layer

18 anti-reflection layer

19 antistatic layer

20 carrier substrate

22 viewing angle compensation layer

25 cover sheet

1. A multilayer optical film, for use in a display or component thereof, comprising one or more functional layers over a substrate, wherein a topmost functional layer is an anti-reflective layer that comprises elongated-shaped organically modified silica particles.

2. The multilayer optical film of claim 1 wherein the anti-reflection layer has a nano-structured surface comprising nano-scale ridges and troughs.

3. The multilayer optical film of claim 1 wherein the anti-reflection layer further comprises interstitial air voids below the nano-structured surface.

4. The multilayer optical film of claim I wherein the anti-reflective layer is made by coating a colloidal solution of elongated-shaped silica particles, the silica particles being present in the anti-reflective layer in an amount from 1 to 99% by weight solids.

5. The multilayer optical film of claim 1 wherein the silica particles are present in the layer in an amount from 5 to 95 weight %.

6. The multilayer optical film of claim 1 wherein the nanoparticles are organically modified with an alkoxy-silane-function compound.

7. The multilayer optical film of claim 1 further comprising a polymer, as a binder material, which can be coated, preformed, or formed in-situ after the layer is coated.

8. The multilayer optical film of claim 7 wherein the polymer, if not crosslinked, has a weight average molecular weight of 500 to 10⁶.

9. The multilayer optical film of claim 7 wherein the polymer is selected from the group consisting of cellulosic, acrylic, and fluorinated polymers.

10. The multilayer optical film of claim 7 wherein the polymer is a UV-cross-linked polymer that is a polymerization product of a coated monomer or oligomer.

11. The multilayer optical film of claim 1 wherein the anti-reflective layer in the multilayer optical film reduces reflection to less than 0.5% for light having a wavelength of 500 to 700 nm.

12. The multilayer optical film of claim 1 wherein the anti-reflective layer has an effective index of refraction of 1.1 to 1.4, as calculated based on reflection.

13. The multilayer optical film of claim 1 wherein the anti-reflective layer has a thickness of 50 nm to 10 micrometers.

14. The multilayer optical film of claim 1 wherein the anti-reflective layer has an RMS surface roughness of 2 to 15.

15. The multilayer optical film of claim 1 wherein the elongated particles have an aspect ratio of greater than 5.

16. The multilayer optical film of claim 1 wherein the substrate comprises a polymeric material or glass.

17. The multilayer optical film of claim 16 wherein the polymeric material is selected from the group consisting of polycarbonate, polyester, polyvinyl acetate, polyvinyl pyrrolidone, polyvinyl chloride, polyimide, polyethylene naphthalate, polytetrafluoro ethylene, nylon, polynorbornenes, glass, silicon, polyethylene terephthalate, and cellulose triacetate.

18. The multilayer optical film of claim 16 wherein the polymeric material is cellulose triacetate or polyethylene terephthalate.

19. The multilayer optical film of claim 1 wherein the multilayer optical film is a display or component thereof.

20. The multilayer optical film of claim 19 wherein the multilayer optical film is a protective cover sheet, useful for a polarizer and wherein the substrate comprises a low birefringence protective polymer film.

21. The multilayer optical film of claim 20 wherein the protective cover sheet further comprises a layer promoting adhesion to poly(vinyl alcohol)-containing films.

22. The multilayer optical film of claim 19 wherein the display or component thereof is a cover sheet composite comprising a low birefringence protective polymer film and at least one other functional layer in addition to the anti-reflectance layer.

23. The multilayer optical film of claim 1 wherein the substrate is a low birefringence protective polymer film and the one or more functional layers comprises an adhesion promoting layer, for adhering a poly(vinyl alcohol)-containing film to the low birefringence protective polymer film, the multilayer optical film further comprising a carrier substrate, wherein the adhesion promoting layer is between the substrate and the low birefringence protective polymer film.

24. The multilayer optical film of claim 1 wherein the one or more functional layers further comprises an anti-glare layer and/or a hardcoat layer.

25. The multilayer optical film of claim 19 wherein the display comprises a polarizing plate in which a protective cover sheet comprises the multilayer optical film.

26. The multilayer optical film of claim 1 wherein the anti-reflective layer is a single-layer anti-reflective film.

27. A method of forming an anti-reflective layer, which method comprises coating, onto a substrate, a coating composition comprising (a) a colloidal solution of elongated-shaped organically modified silica nanoparticles; (b) an optional binder material, comprising a polymer, or oligomeric or monomeric precursor thereof; (c) optional organic solvent, wherein the silica nanoparticles are present in the coating composition in an amount from 1 to 99% by weight solids; and (d) drying the coating to remove organic solvent, thereby forming an anti-reflective layer. and form a silica-polymer nanocomposite film.

28. The method of claim 27 wherein the anti-reflective layer is a silica-polymer nanocomposite film.

29. The method of claim 27 wherein the anti-reflective layer has a nano-structured surface comprising nano-scale ridges and troughs.

30. The method of claim 29 wherein the anti-reflection layer further comprises interstitial air voids below the nano-structured surface.

31. The method of claim 27, wherein the coating composition further comprises a polymerization initiator.

32. The method of claim 27, wherein the coating composition further comprises a crosslinking agent for a polymer or oligomer.

33. The method of claim 27, wherein after applying the coating composition, solid materials are not removed from the coating in order to obtain nanovoids.

34. A method of forming a polarizing plate comprising:
(a) providing a front cover sheet composite comprising:
(i) an optional carrier substrate; and
(ii) a protective cover sheet in the form of a multilayer optical film as in claim 1;
(b) providing a poly(vinyl alcohol)-containing dichroic film; and
(c) bringing the protective cover sheet into contact with the poly(vinyl alcohol)-containing dichroic film.

35. The method of claim 34 wherein a layer promoting adhesion to a poly(vinyl alcohol)-containing film is present in the protective cover sheet and is contacted with the poly(vinyl alcohol)-containing dichroic film when bringing the protective cover sheet into contact with the poly(vinyl alcohol)-containing dichroic film.

36. The method of claim 34 wherein there is a back cover sheet composite which is simultaneously or sequentially, with the front cover sheet composite, brought into contact with the poly(vinyl alcohol)-containing dichroic film.

37. A method of forming a polarizing plate comprising providing two cover sheets as in claim 1, providing a poly(vinyl alcohol)-containing dichroic film, and simultaneously or sequentially bringing the cover sheets into contact with the poly(vinyl alcohol)-containing dichroic film such that the layer promoting adhesion to a poly(vinyl alcohol)-containing film in each of the two cover sheets is in contact with the poly(vinyl alcohol)-containing dichroic film, wherein at least one of the layers promoting adhesion comprises water-soluble polymer and hydrophobic polymer particles.
